(19) United States
(12) Patent Application Publication
(10) Pub. No.: US 2020/0239754 A1
(43) Pub. Date: Jul. 30, 2020

(54) FUGITIVE EMISSION-SUPPRESSANT AND NON-CORROSIVE AGENT, FUGITIVE EMISSION REDUCTION PROCESS, COMPOSITION, AGENT USE AND PARTICULATE PRODUCT

(71) Applicant: CARGILL, INCORPORATED, Wayzata, MN (US)

(72) Inventors: Rodrigo Simioni CURA, São Paulo (BR); Marcos Cesar de Carvalho FERNANDEZ, São Paulo (BR); Helio Haruo USHIJIMA, São Paulo (BR)

(73) Assignee: CARGILL, INCORPORATED, Wayzata, MN (US)

(21) Appl. No.: 16/754,303

(22) PCT Filed: Oct. 9, 2018
(86) PCT No.: PCT/US2018/054978

§ 371 Date: Apr. 7, 2020

(30) Foreign Application Priority Data
Oct. 9, 2017 (BR) 102017021676.4
Sep. 24, 2018 (BR) 102018069403.0

(51) Int. Cl. C09K 3/22; B65G 69/18

(52) U.S. Cl. CPC C09K 3/22; B65G 69/18

(57) ABSTRACT

The present invention concerns a composition for suppressing formation and transmission of dust particles. Such de-dusting of particulate products has benefits in health and safety as well as preventing corrosive effects of dust particles. The composition comprises high quality glycerin substantially free of chloride and sulfate salts. Further uses for the compositions described herein are also provided.

### CROSS-REFERENCE TO RELATED APPLICATIONS

This application claims the benefit of Brazilian Patent Application Serial No. 102017021676, filed 9 Oct. 2017 and Brazilian Patent Application Serial No. 102018069403.0, filed 24 Sep. 2018. both of which applications are hereby incorporated by reference herein in their entirety.

### FIELD OF THE INVENTION

The present invention generally concerns an agent with both fugitive emission suppressing and non-corrosive effects, for dust-issuing particulate products, containing glycerin and water. The fugitive emissions suppressing concerns controlling dust emissions from particulate products, for instance, grains, particularly during handling, storage and transportation thereof. The non-corrosive effect relates to the effect upon steel typically employed in equipment and piping ordinarily employed in handling, storage and transportation of particulate products whose movement generates dust.

### BACKGROUND OF THE INVENTION

The fugitive emissions suppressing is defined as the prevention or reduction of the amount of fine airborne particles.

Dust emission of fine airborne particles is a known problem particularly associated with the movement of particulate products, for instance, grains.

In the text that follows, the verb “handling” is employed to denote any Kind of movement able to promote fugitive emissions, such as handling, production, storage and transportation of particulate products.

Fugitive emissions (dust) resulting from the movement of particulate products can raise ecological concerns and can be irritating to persons upon short-term exposure.

The grains movement is a source of fugitive emissions that raises concerns, particularly regarding the possibility of explosions caused by dust. The grains fugitive emissions are highly combustible and may burn or explode if sufficient amount goes into the air or accumulates on a surface, with a source of ignition nearby.

Depending on the type of product or particulate substrate, emitting fugitive emissions a simple remediation like aspiration and/or water spray may be applied. Otherwise, particulate products are treated with additive agents to reduce dust formation levels.

For the fertilizer and mineral industries, for example, fugitive emission-suppressant agents are quaternary compounds, petroleum-based products, polymers and hydrogenated mineral oil. For handling grains, a very typical fugitive emission suppressing agent is food-grade mineral oil.

A constant search in the field of fugitive emissions suppressing agents has targeted the use of biodegradable materials, as well as industrial by-products, including vegetable oils, molasses, saccharides and carbohydrates (including starch) ligno sulfonate, glycerin, etc.

Glycerin as a by-product of biodiesel transesterification, without previous treatment, also called crude glycerin, one of the prior-art cited fugitive emissions-suppressants agents, is a by-product of the biodiesel production. For each 1000 l of biodiesel production, approximately 100 kg of glycerin are generated. It typically contains contaminants like salts (particularly chlorides and sulfates), methanol, soaps, heavy metals, water and residual fatty acids.

Specifically concerning the use of glycerin as fugitive emissions-suppressant agent representative prior-art can be mentioned:

YAN, W. and Hoekman, S.—“Dust Suppression with Glycerin from Biodiesel Production: A review”—Journal of Environmental Protection, 2012, 3, 218-224. In this article glycerin, alone or combined with surfactants, polymers and other chemicals, is proposed as a specific fugitive emissions suppressant for, instance, treating, erodible natural dust, unpaved roads, mineral storage piles, mineral and/or coal transportation in cars or trucks; there is no mention of the quality of glycerin, or of to corrosion caused by the use of it as anti-dust.

Patent application US 2002/0184933—This document discloses applying polyhydric alcohol anti-dust agents, such as glycerin, for treatment of particular inorganic materials, for example fertilizers, during processing and handling. There is no mention to the glycerin quality or corrosion caused by their use as anti-dust.

The use of glycerin as fugitive emission-suppressant agent for handling particulate products in replacement for mineral oil, raises another problem, namely the corrosion caused by salts like chloride and sulfate, caused to the iron type typically employed in equipment and piping contacted by said particulate products.

Despite the fact that glycerin may be extensively treated, for instance with bi-distillation, to lower the content of such salts to an acceptable non-corrosive level, the cost would not be competitive with other fugitive emission-suppressant agents, such as mineral oil.

On the other hand, the use of mineral oil as the fugitive emission-suppressant, while not a strong corrosion promoter, results in the premature wear of the conveyor belts, as it causes dryness of the rubber and cracks that during the service life cause the belts to break.

The present invention aims at overcoming the problems of employing glycerin as a cost effective fugitive emission-suppressant in replacement to mineral oil, without incurring in increased corrosion, and allowing less frequent maintenance in equipment and pipping involved in the handling of particulate products. The fugitive emission-suppressant and non-corrosive agent of the invention may be described as comprising an aqueous chloride- and sulfate-free glycerin, as well as vegetable oils and/or derivate thereof.

### DESCRIPTION OF THE INVENTION

“Suppressant”, as in the expression “fugitive emission-suppressant”, according to the meaning employed in the context of this invention also connotes decreasing, diminishing, controlling, reducing, preventing or inhibiting dust formation.

With respect to this invention, the use of an aqueous glycerin chloride- and sulfate-free agent in the control of emission of fugitive emissions during manufacturing, handling, storage or transportation of particulate products like grains and derivatives (bran) of soybean, corn, wheat, malt, barley, and other cereals and/or other bulk transported, proved to overcome the inconveniences related to both the emissions of fugitive emission as well as the corrosion.

Chloride- and sulfate-free glycerin according to the present invention means substantially chloride- and sulfate-free glycerin, with contents up to 200 ppm of either one or both salts.

Some processes of alkaline catalytic transesterification of triglycerides with methanol or ethanol produces glycerin with about 7% of salts, mostly chloride and sulfate salts. Accordingly, glycerin from this source is not advantageous for the present invention.

On the other hand the manufacturing process through acid catalytic transesterification of triglycerides with methanol/ethanol produces glycerin from very low to almost no chloride and sulfate content. Non-limiting examples of processes of this nature are those associated to the biodiesel production. Accordingly, the glycerin from that source is advantageous to the present invention since the presence of other components, such as chloride and sulfate salts, does not affect its fugitive emissions-suppressant activity, nor cause substantial corrosion to equipment and pipes in contact with particulate products.

Also suitable for the present invention are glycerins from scission (oilchemistry) or saponification (soaps).

The preferred raw material for the production of biodiesel that will have glycerin as a possible by-product employed in this invention is vegetable oil, particularly soybean oil.

According to one aspect of the invention, a process for reducing the formation of a fugitive emission in particulate products, during handling of such products comprises applying to the particulate product an effective amount of an aqueous chloride- and sulfate-free glycerin agent.

A particular content of water in the aqueous chloride- and sulfate-free glycerin agent of the invention ranges from 10% to about 90%, preferably from 20% to about 30% in weight with respect to the total weight of the glycerin/water mixture.

Another aspect of the invention concerns a fugitive emissions-suppressant and non-corrosive agent for dust-issuing particulate products, characterized by the fact that it comprises an aqueous glycerin, substantially chloride- and sulfate-free. Typically, substantially chloride- and sulfate-free glycerin is diluted with water to prepare the agent of the invention. Dilution of the glycerin is useful for adjusting its viscosity. The appropriate viscosity range according to the present invention ranges from about 10 cP to about 1000 cP, preferably about 100 cP (centipoise).

A particulate material having reduced emissions of fugitive emission comprises inorganic or organic particles coated with an effective amount of the fugitive emission-suppressant and non-corrosive agent of the invention which cost effective in reducing dust formation in the handling of particulate materials, overcoming the drawbacks of previous oil-, petroleum-, wax-based or high salt content anti-dust agents. The aqueous glycerin agent of the invention is environmentally safe.

As herein used, “dust” or “fugitive emission” refers to airborne particles, most of which are about 10 microns or less, created during the production, handling, storage and transportation of particulate products that, under those circumstances, promote the formation of organic or inorganic fine materials. In addition, it may comprise soil residues, cereal fragments, fibers, barks, fertilizers, microorganisms, animal feces, among others.

The glycerin employed to make the aqueous glycerin agent of the invention is at least 85% pure, with less than 200 ppm of chlorides and/or sulfates.

The amount of fugitive emission-suppressant and non-corrosive agent of the invention, applied to particulate products must be at least a minimum amount that provides a relevant reduction in the dust formation, with no particular maximum amount—the practical limiting factor would be cost. Of course, the fugitive emission-suppressant and non-corrosive agent preferably should not be present in excessive concentrations that might adversely affect the desired physical and/or chemical properties of the treated particulate product.

A particular amount direct to the fugitive emissions suppressing of the aqueous glycerin agent of the invention, without exclusion of any other ranges from 0.2 to 2.0% in weight with respect to the total weight of the emitting particulate product of fugitive emission.

The fugitive emission-suppressant and non-corrosive agent of the invention may be composed with other ingredients, as necessary, as a person skilled in the art will know. This is also a further aspect of the invention, a composition comprising the aqueous glycerin agent described previously and containing further active ingredients and vehicles.

In still other aspects, the present invention also encompasses:
the use of an aqueous glycerin agent described previously as fugitive emission-suppressant and non-corrosive agent, and
a dust-issuing particulate product with reduced fugitive emission comprising the aqueous glycerin agent describe previously as fugitive emission-suppressant and non-corrosive agent.

A person skilled in the art with the aid of the information and examples contained herein will be able to execute the invention in an equivalent manner, that is, although performing in a different manner from the ones disclosed, but performing the same or substantially the same function to achieve the same or substantially the same result. Such equivalent embodiments are within the scope of protection of the invention defined in the attached claims.

1. Fugitive emission-suppressant and non-corrosive agent for dust-issuing particulate products, characterized by the fact that it comprises glycerin which is substantially free of chloride and sulphate and water and/or vegetable oils and/or derivatives thereof.

2. Fugitive emission-suppressant and non-corrosive agent according to claim 1, characterized by the fact that the content of chlorides and/or sulfates in the glycerin is less than 200 ppm.

3. Fugitive emission-suppressant and non-corrosive agent according to claim 1, characterized by the fact that the glycerin employed to prepare said aqueous glycerin agent is at least 85% pure.

4. Fugitive emission-suppressant and non-corrosive agent according to claim 1, characterized by the fact that the glycerin employed in said aqueous glycerin agent is obtained via acid catalytic transesterification of triglycerides with methanol or ethanol.

5. Fugitive emission-suppressant and non-corrosive agent according to claim 1, characterized by a content of water in the range of 10% to 90% in weight with respect to the total weight of the glycerin and water mixture.

6. Fugitive emission-suppressant and non-corrosive agent according to claim 5, characterized by a content of water in the range of 20% to 30% in weight with respect to the total weight of the glycerin and water mixture.

7. A process of reducing the formation of fugitive emission in dust-issuing particulate products characterized by the fact that comprises applying to said particulate product, an effective amount of aqueous chloride- and sulfate-free glycerin agent according to claim 1.

8. The process according to claim 7, characterized by the fact that the amount of said aqueous agent range from 0.2 to 2.0% in weight with respect to the total weight of the dust issuing particulate product.

9. A composition characterized by the fact that it comprises the aqueous chloride- and sulfate-free glycerin agent according to claim 1, and further active ingredients and vehicles.

10. The use of the agent described in claim 1, characterized by the fact that is a fugitive emission-suppressant and non-corrosive agent.

11. A dust-issuing particulate product with reduced fugitive emission characterized by the fact that it comprises the aqueous glycerin agent according to claim 1 as fugitive emission-suppressant and non-corrosive agent.
